(19) United States
(12) Patent Application Publication
(10) Pub. No.: US 2021/0148571 A1
(43) Pub. Date: May 20, 2021

(54) PLUME SUPPRESSION WITH THERMOSYPHON SHELL AND TUBE HEAT EXCHANGERS

(71) Applicant: MECS, INC., Chesterfield, MO (US)

(72) Inventors: Lawrence F. PASCHKE, ST. LOUIS, MO (US); Steven F. MEYER, FLORISSANT, MO (US)

(21) Appl. No.: 17/258,876

(22) PCT Filed: Jun. 28, 2019
(86) PCT No.: PCT/US2019/039823

§ 371 Date: Jan. 8, 2021

Related U.S. Application Data
(60) Provisional application No. 62/696,559, filed on Jul. 11, 2018.

(51) Int. Cl. F23J 15/04; F23J 15/06; F28D 7/16; F28D 15/02; B01D 53/14

(52) U.S. Cl. CPC F23J 15/04; F23J 15/06; F28D 7/16; F23J 2900/15081; B01D 53/1431; F23J 2219/40; F23J 2900/15004; F28D 15/02

(57) ABSTRACT

This disclosure relates to a process for steam plume suppression. The process involves using thermosyphon shell and tube heat exchangers to cool a hot gas stream, using a wet scrubber to clean the cooled hot gas stream and generate a wet gas comprising water vapor, and using thermosyphon shell and tube heat exchangers to heat the wet gas above the dew point. This disclosure also relates to a steam plume suppression system. The system involves thermosyphon shell and tube heat exchangers and a wet scrubber.

### CROSS-REFERENCE TO RELATED APPLICATION

This application claims priority of U.S. Patent Application 62/696,559 filed on Jul. 11, 2018, the disclosure of which is incorporated herein by reference in its entirety for all purposes.

### BACKGROUND

### Field of the Disclosure

The present disclosure relates to steam plume suppression process and system to reduce or eliminate a steam plume from a wet scrubber.

Specifically, the steam plume is reduced or eliminated by using thermosyphon shell and tube heat exchangers.

### Description of Related Art

Various industrial processes produce gaseous streams containing particulate and gaseous components (e.g., sulfur oxides and other sulfur compounds such as SO₂, SO₃, H₂S and H₂SO₄). Such processes include, but are not limited to, for example, fossil fuel-fired power plants, natural gas treatment plants, refineries (e.g., fluid catalytic cracking (FCC) units), sulfur recovery units (SRUs), sulfuric acid plants, metal roasting operations, cement kilns and synthesis gas plants. Before such gas streams can be vented to the atmosphere, they must often be treated to remove the particulate and gaseous impurities. In industry, wet scrubbers such as DynaWave® Reverse Jet Scrubbers are commonly used to treat and remove particulate and gaseous impurities from gaseous industrial process streams.

### BRIEF SUMMARY OF THE DISCLOSURE

The present disclosure provides a process for steam plume suppression. The process comprises (a) providing a cooling shell and tube heat exchanger, a heating shell and tube heat exchanger, and a heat transfer fluid to be circulated on the shell side between the cooling shell and tube heat exchanger and the heating shell and tube heat exchanger (b) passing a hot gas stream through the tube side of the cooling shell and tube heat exchanger to heat a liquid heat transfer fluid contained on the shell side of the cooling shell and tube heat exchanger to form a heat transfer fluid vapor while the hot gas stream is cooled to form a cooled hot gas stream; (c) circulating the heat transfer fluid vapor to the shell side of the heating shell and tube heat exchanger; (d) passing a wet gas comprising water vapor through the tube side of the heating shell and tube heat exchanger so that the wet gas is heated to above the dew point and the heat transfer fluid vapor contained on the shell side of the heating shell and tube heat exchanger is cooled and condensed to form the liquid heat transfer fluid; and (e) circulating the liquid heat transfer fluid to the shell side of the cooling shell and tube heat exchanger; wherein the cooled hot gas stream exiting from the tube side of the cooling shell and tube heat exchanger is directed to a wet scrubber to generate the wet gas comprising water vapor.

The present disclosure also provides a steam plume suppression system. The system comprises (a) a cooling shell and tube heat exchanger comprising a shell side inlet, a shell side outlet, a tube side inlet and a tube side outlet; (b) a heating shell and tube heat exchanger comprising a shell side inlet, a shell side outlet, a tube side inlet and a tube side outlet; and (c) a wet scrubber comprising a gas inlet and a scrubbed gas outlet; wherein the tube side outlet of the cooling shell and tube heat exchanger is connected with the gas inlet of the wet scrubber, the scrubbed gas outlet of the wet scrubber is connected with the tube side inlet of the heating shell and tube heat exchanger, the shell side outlet of the cooling shell and tube heat exchanger is connected with the shell side inlet of the heating shell and tube heat exchanger, and the shell side outlet of the heating shell and tube heat exchanger is connected with the shell side inlet of the cooling shell and tube heat exchanger.

The present disclosure further provides a process for steam plume suppression. The process comprises (a) providing a cooling shell and tube heat exchanger, a heating shell and tube heat exchanger, and a heat transfer fluid to be circulated on the tube side between the cooling shell and tube heat exchanger and the heating shell and tube heat exchanger; (b) passing a hot gas stream through the shell side of the cooling shell and tube heat exchanger to heat a liquid heat transfer fluid contained on the tube side of the cooling shell and tube heat exchanger to form a heat transfer fluid vapor while the hot gas stream is cooled to form a cooled hot gas stream; (c) circulating the heat transfer fluid vapor to the tube side of the heating shell and tube heat exchanger; (d) passing a wet gas comprising water vapor through the shell side of the heating shell and tube heat exchanger so that the wet gas is heated to above the dew point and the heat transfer fluid vapor contained on the tube side of the heating shell and tube heat exchanger is cooled and condensed to form the liquid heat transfer fluid; and (e) circulating the liquid heat transfer fluid to the tube side of the cooling shell and tube heat exchanger; wherein the cooled hot gas stream exiting from the shell side of the cooling shell and tube heat exchanger is directed to a wet scrubber to generate the wet gas comprising water vapor.

The present disclosure also provides a steam plume suppression system. The system comprises (a) a cooling shell and tube heat exchanger comprising a shell side inlet, a shell side outlet, a tube side inlet and a tube side outlet; (b) a heating shell and tube heat exchanger comprising a shell side inlet, a shell side outlet, a tube side inlet and a tube side outlet; and (c) a wet scrubber comprising a gas inlet and a scrubbed gas outlet; wherein the shell side outlet of the cooling shell and tube heat exchanger is connected with the gas inlet of the wet scrubber, the scrubbed gas outlet of the wet scrubber is connected with the shell side inlet of the heating shell and tube heat exchanger, the tube side outlet of the cooling shell and tube heat exchanger is connected with the tube side inlet of the heating shell and tube heat exchanger, and the tube side outlet of the heating shell and tube heat exchanger is connected with the tube side inlet of the cooling shell and tube heat exchanger.

The present disclosure further provides a process for steam plume suppression. The process comprises (a) providing an integrated shell and tube heat exchanger comprising a shell, a plurality of tubes, and a substantially horizontal tube sheet sealingly engaging the tubes and an interior wall of the shell and defining an upper chamber and a lower chamber within the integrated shell and tube heat exchanger, wherein the plurality of tubes extend upwardly from the lower chamber to the upper chamber; (b) providing a heat transfer fluid to be circulated on the tube side between the lower chamber and the upper chamber, (c) passing a hot gas stream through the shell side of the lower chamber to heat a liquid heat transfer fluid contained on the tube side of the lower chamber to form a heat transfer fluid vapor which rises to the tube side of the upper chamber while the hot gas stream is cooled to form a cooled hot gas stream; and (d) passing a wet gas comprising water vapor through the shell side of the upper chamber so that the wet gas is heated to above the dew point and the heat transfer fluid vapor contained on the tube side of the upper chamber is cooled and condensed to form the liquid heat transfer fluid which is circulated to the tube side of the lower chamber wherein the cooled hot gas stream exiting from the shell side of the lower chamber is directed to a wet scrubber to generate the wet gas comprising water vapor.

The present disclosure further provides a steam plume suppression system. The system comprises: (a) an integrated shell and tube heat exchanger comprising a shell, a plurality of tubes, and a substantially horizontal tube sheet sealingly engaging the tubes and an interior wall of the shell and defining an upper chamber and a lower chamber within the integrated shell and tube heat exchanger, wherein the plurality of tubes extend upwardly from the lower chamber to the upper chamber, and the upper chamber and the lower chamber each has a shell side inlet and a shell side outlet; and (b) a wet scrubber comprising a gas inlet and a scrubbed gas outlet; wherein the shell side outlet of the lower chamber is connected with the gas inlet of the wet scrubber, and the scrubbed gas outlet of the wet scrubber is connected with the shell side inlet of the upper chamber.

### BRIEF DESCRIPTION OF THE FIGURES

Embodiments are illustrated in the accompanying figures to improve understanding of concepts as presented herein.

FIG. 1 is a schematic process flow diagram of a process for steam plume suppression by using two shell and tube heat exchangers. FIG. 1 is also a schematic showing a steam plume suppression system.

FIG. 2 is a schematic process flow diagram of a process for steam plume suppression by using an integrated shell and tube heat exchanger. FIG. 2 is also a schematic showing a steam plume suppression system.

FIG. 3 is a schematic process flow diagram of a process for steam plume suppression by using two shell and tube heat exchangers. FIG. 3 is also a schematic showing a steam plume suppression system.

Corresponding reference characters indicate corresponding parts throughout the drawings. Skilled artisans appreciate that objects in the figures are illustrated for simplicity and clarity and have not necessarily been drawn to scale. For example, the dimensions of some of the objects in the figures may be exaggerated relative to other objects to help to improve understanding of embodiments.

### DETAILED DESCRIPTION

The foregoing general description and the following detailed description are exemplary and explanatory only and are not restrictive of the invention, as defined in the appended claims. Other features and benefits of any one or more of the embodiments will be apparent from the following detailed description, and from the claims.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition A or B is satisfied by any one of the following: A is true (or present) and B is false (or not present), A is false (or not present) and B is true (or present), and both A and B are true (or present).

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. In case of conflict, the present specification, including definitions, will control. Although methods and materials similar or equivalent to those described herein can be used in the practice or testing of embodiments of the present invention, suitable methods and materials are described below. In addition, the materials, methods, and examples are illustrative only and not intended to be limiting.

When an amount, concentration, or other value or parameter is given as a range, preferred range or a list of upper preferable values and/or lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

Before addressing details of embodiments described below, some terms are defined or clarified.

A shell and tube heat exchanger typically has a shell (e.g., a pressure vessel) with a bundle of tubes inside it. One fluid runs through the tubes (i.e., tube side), and another fluid flows over the tubes (through the shell, or shell side) to transfer heat between the two fluids. The term “shell side”, as used herein, means that the fluid flows over the outside of the tubes (i.e. within the shell). The term “tube side”, as used herein, means that the fluid flows through the tubes.

Thermosyphon (or thermosiphon) is a method of passive heat exchange, based on natural convection, which circulates a fluid without the necessity of a mechanical pump. The term “thermosyphon heat exchanger”, as used herein, means an integrated shell and tube heat exchanger or a combination of two shell and tube heat exchangers wherein the heat transfer fluid is circulated without using a pump. In some embodiments, the heat transfer fluid is water.

The term “liquid heat transfer fluid”, as used herein, means the heat transfer fluid in liquid state.

The term “heat transfer fluid vapor”, as used herein, means the heat transfer fluid in gaseous state.

The terms “upstream” and “downstream”, as used herein, are defined with respect to the flow direction of the process gas stream.

The term “wet gas”, as used herein, means the cleaned cooled hot gas stream exiting the scrubbed gas outlet which is located downstream of the at least one scrubbing zone and the gas/liquid separation device (if present) contained in the wet scrubber.

The term “dew point”, as used herein, means the temperature to which the air would have to be cooled (at constant pressure and constant water vapor content) in order to reach saturation. A state of saturation exists when the air is holding the maximum amount of water vapor possible at the existing temperature and pressure.

The term “vol %”, as used herein, means percentage by volume.

The term, “ppmv”, as used herein, means parts per million by volume.

The term, “psia”, as used herein, means pounds per square inch absolute and indicates a pressure relative to a vacuum.

The term, “directly connected”, as used herein, means that two devices are directly fluidly connected without an intermediate device in between such as a cooling or heating device (e.g., a heat exchanger), a purification or treatment device, a separation device (e.g., a liquid/vapor separator), a mixer, or a storage vessel. In some embodiments, the two devices can be directly connected with a conduit.

### Hot Gas Stream

In this disclosure, a hot gas stream comprises particulate and/or gaseous contaminants which must be removed before the gas stream can be vented to the atmosphere. In some embodiments, the hot gas stream is the hot flue gas emitted from combustion, fluid catalytic cracking unit (FCCU), sulfur recovery unit (SRU) and other operations. In some embodiments, the hot gas stream comprises sulfur oxides (SOx) and/or nitrogen oxides (NOₓ). Examples of sulfur oxides (SOx) include SO₂ and SOS. Examples of nitrogen oxides (NOₓ) include NO and NO₂. In some embodiments, the hot gas stream comprises sulfur oxides (SOx) and is essentially free of nitrogen oxides (NOₓ). In some embodiments, the hot gas stream comprises no more than 100 ppmv, or no more than 50 ppmv, or no more than 20 ppmv, or no more than ppmv, or no more than 5 ppmv nitrogen oxides (NOₓ). A hot gas stream typically also comprises nitrogen (N₂), oxygen (O₂), water vapor, and carbon dioxide (CO₂). In some embodiments, the hot gas stream also comprises H₂S and/or H₂SO₄.

In some embodiments, the hot gas stream has a temperature ranging from about 150° C. to about 700° C., or from about 175° C. to about 600° C., or from about 200° C. to about 500° C., or from about 200° C. to about 400° C., or from about 250° C. to about 350° C. In some embodiments, the hot gas stream has water vapor content ranging from about 5 vol % to about 35 vol %, or from about 10 vol % to about 35 vol %, or from about 15 vol % to about 35 vol %, or from about 20 vol % to about 35 vol %, or from about 25 vol % to about 35 vol %, or from about 25 vol % to about 30 vol % based on the total volume of the hot gas stream.

### Heat Transfer Fluid

In this disclosure, the heat transfer fluid is thermally stable and non-corrosive to components of the heat exchanger. It is also typically non-toxic. In some embodiments, the heat transfer fluid has a normal boiling point (i.e., boiling point under the atmospheric pressure) ranging from about 50° C. to about 250° C., or from about 60° C. to about 200° C., or from about 70° C. to about 170° C., or from about 80° C. to about 150° C., or from about 80° C. to about 130° C., or from about 90° C. to about 120° C.

In some embodiments, the heat transfer fluid is selected from the group consisting of water, ethylene glycol, diethylene glycol, propylene glycol, alcohols, ethers, hydrocarbons, partially or fully fluorinated hydrocarbons, partially or fully fluorinated ethers, and combinations thereof. In some embodiments, the heat transfer fluid comprises, consists essentially of, or consists of water.

### Wet Scrubber

The cooled hot gas stream is directed to a wet scrubber so that the particulate and gaseous impurities contained therein can be removed. In some embodiments, the cooled hot gas stream is transferred to the gas inlet of the wet scrubber without intermediate removal of heat or intermediate addition of heat. In some embodiments, the cooled hot gas stream is transferred into the gas inlet of the wet scrubber without passing through an intermediate heat exchanger device between the cooling shell and tube heat exchanger and the wet scrubber or between the integrated shell and tube heat exchanger and the wet scrubber. Wet scrubbers have been described in U.S. Pat. No. 7,534,400, WO2008/100317 and US2016/0317964, and their disclosures are incorporated herein by reference in their entirety for all purposes. In some embodiments, the wet scrubber is a reverse jet scrubber such as a DynaWave® reverse jet scrubber. A reverse jet scrubber has been described in U.S. Pat. No. 3,803,805, the disclosure of which is incorporated herein by reference in its entirety for all purposes. In some embodiments, the wet scrubber is a BELCO® wet scrubber. A BELCO® wet scrubbing system has been described by Weaver et al. in “An Update of Wet Scrubbing Control Technology for FCCUS-Multiple Pollutant Control” AM-03-120, NPRA, (2003), the disclosure of which is incorporated herein by reference in its entirety for all purposes.

Generally, a wet scrubber is a type of gas pollution control device, which is used to remove fine particles and/or gaseous impurities from industrial exhaust streams. The wet scrubber comprises a gas inlet for receiving the gas stream to be treated (e.g., the cooled hot gas stream in this disclosure) into the wet scrubber and a scrubbed gas outlet for discharging the cleaned wet gas stream (e.g., the cleaned cooled hot gas stream or “wet gas” in this disclosure) from the wet scrubber. Typically, a wet scrubber is a gas-liquid contacting device comprising at least one scrubbing zone where the gas stream to be treated contacts an aqueous scrubbing liquid. In some embodiments, the cooled hot gas stream is contacted with a scrubbing liquid to be adiabatically saturated or “quenched” in a scrubbing zone in the wet scrubber. In some embodiments, the scrubbing liquid is an aqueous solution comprising a basic reagent and having a pH of at least about 8.5.

In some embodiments, the wet scrubber is a reverse jet scrubber wherein at least one jet of an aqueous scrubbing liquid contacts the cooled hot gas stream countercurrently in a scrubbing zone. In some embodiments, the wet scrubber is equipped with a plurality of spray nozzles each of which sprays an aqueous scrubbing liquid substantially horizontally towards the interior wall of a scrubbing zone and produces high density aqueous scrubbing liquid curtains through which the cooled hot gas stream passes in a cross-flow fashion.

In some embodiments, the wet scrubber further comprises a gas/liquid separation device located downstream of the at least one scrubbing zone. In some embodiments, the gas/liquid separation device comprises a chevron demister (e.g., a vertical flow chevron demister) and/or a mist eliminator. When the chevron demister and the mist eliminator are both present, the mist eliminator is typically located downstream of the chevron demister. The scrubbed gas stream leaving the at least one scrubbing zone passes through the gas/liquid separation device to remove the entrained liquid droplets (e.g., water droplets) before it enters the scrubbed gas outlet and is discharged from the wet scrubber.

### Wet Gas

In this disclosure, the wet gas comprises high water vapor content. In some embodiments, the wet gas is substantially saturated with water vapor under the temperature and pressure of the wet gas at the scrubbed gas outlet. In some embodiments, the wet gas is within about 20%, or about 15%, or about 10%, or about 5% of the water vapor saturation point under the temperature and pressure of the wet gas at the scrubbed gas outlet. For example, if the water vapor saturation point means that the wet gas comprises vol % water vapor based on the total volume of the wet gas, the term “within 20% of the water vapor saturation point” means the water vapor content ranging from 28 vol % (0.8×35 vol %) to 42 vol % (1.2×35 vol %) water vapor content.

In some embodiments, the wet gas has water vapor content ranging from about 10 vol % to about 50 vol %, or from about 15 vol % to about 45 vol %, or from about 20 vol % to about 40 vol %, or from about 25 vol % to about vol % based on the total volume of the wet gas.

In some embodiments, the pressure of the wet gas at the scrubbed gas outlet is about the atmospheric pressure. In some embodiments, the temperature of the wet gas at the scrubbed gas outlet ranges from about 40° C. to about 80° C., or from about 45° C. to about 80° C., or from about 50° C. to about 80° C., or from about 55° C. to about 75° C., or from about 60° C. to about 75° C.

In some embodiments of this disclosure, the wet gas exiting from the wet scrubber is substantially free of the particulate and/or gaseous contaminants contained in the hot gas stream. In some embodiments, the wet gas comprises no more than about 100 ppmv, or no more than about 50 ppmv, or no more than about 40 ppmv, or no more than about 30 ppmv sulfur oxides (SOx) based on the total volume of the wet gas. In some embodiments, the wet gas comprises no more than about 100 ppmv, or no more than about 50 ppmv, or no more than about 40 ppmv, or no more than about 30 ppmv nitrogen oxides (NOₓ) based on the total volume of the wet gas.

### Heated Wet Gas

In the heating shell and tube heat exchanger or on the shell side of the upper chamber of the integrated shell and tube heat exchanger, the wet gas is heated by the heat transfer fluid vapor to above the dew point to form a heated wet gas. In some embodiments, the wet gas is heated to a temperature at least about 80° C., or 70° C., or 60° C., or 50° C., or 40° C., or 30° C., or 20° C., or 10° C. above the dew point, that is, the heated wet gas has a temperature at least about 80° C., or 70° C., or 60° C., or 50° C., or 40° C., or 30° C., or 20° C., or 10° C. above the dew point. Typically, the wet gas is heated to a temperature no more than 300° C., or 200° C., or 150° C., or 100° C. above the dew point, that is, the heated wet gas has a temperature no more than 300° C., or 200° C., or 150° C., or 100° C. above the dew point.

In some embodiments, the heated wet gas has a temperature of from about 80° C. to about 600° C., or from about 90° C. to about 500° C., or from about 100° C. to about 400° C., or from about 100° C. to about 300° C., or from about 100° C. to about 250° C., or from about 100° C. to about 200° C., or from about 100° C. to about 150° C., or from about 110° C. to about 300° C., or from about 120° C. to about 250° C., or from about 130° C. to about 250° C., or from about 140° C. to about 220° C., or from about 150° C. to about 200° C.

In some embodiments, the temperature difference between the heated wet gas and the wet gas is at least 30° C., or at least 35° C., or at least 40° C., or at least 45° C., or at least 50° C., or at least 55° C., or at least 60° C., or at least 65° C., or at least 70° C., or at least 75° C., or at least 80° C., or at least 85° C., or at least 90° C., or at least 95° C., or at least 100° C.

In some embodiments, the heated wet gas can be discharged directly into the atmosphere. In some embodiments, in the processes of this disclosure, no additional gas (e.g., air or heated air) is added to the process gas stream (i.e., hot gas stream, cooled hot gas stream, wet gas and heated wet gas) throughout the process. By “process gas stream”, it is meant herein the gas stream treated during the process of this disclosure. It can be hot gas stream, cooled hot gas stream, wet gas, or heated wet gas, depending on the stage of the process. In some embodiments, no additional gas (e.g., air or heated air) is added to the process gas stream downstream of the at least one scrubbing zone or downstream of the gas/liquid separation device (if present) and before or when the process gas stream is discharged into the atmosphere.

### Thermosyphon Heat Exchanger System

In some embodiments, a cooling shell and tube heat exchanger and a heating shell and tube heat exchanger are combined or work together to form a thermosyphon heat exchanger wherein a heat transfer fluid is circulated between the cooling shell and tube heat exchanger and the heating shell and tube heat exchanger without using a pump. The cooling shell and tube heat exchanger is used herein to reduce the temperature of the hot gas stream before it is introduced into a wet scrubber.

In some embodiments, the integrated shell and tube heat exchanger is a thermosyphon heat exchanger wherein the heat transfer fluid is circulated on the tube side between the lower chamber and the upper chamber during the operation without using a pump. The liquid heat transfer fluid in the lower section of the tube (i.e., the part of the tube located at the lower chamber) is heated and evaporated by the hot gas stream to form a heat transfer fluid vapor which rises to the upper section of the tube (i.e., the part of the tube located at the upper chamber). The heat transfer fluid vapor in the upper section of the tube is cooled and condensed by the wet gas to form a liquid heat transfer fluid which sinks to the lower section of the tube.

In a wet scrubber, an aqueous scrubbing liquid is typically contacted with the incoming gaseous stream (e.g., flue gas) to adiabatically saturate, or “quench,” the gaseous stream. As a result, the treated gaseous stream exiting the wet scrubber is saturated with water vapor. When such gaseous stream is discharged into the atmosphere out of a stack, the contained water vapor condenses upon contact with the cooler atmosphere and creates a steam plume. Although steam plume is harmless, it is visually unappealing and creates public perception of pollution. Therefore, there is a need to reduce or eliminate the steam plume generated by the wet scrubber.

The present disclosure provides a process for steam plume suppression. The process comprises (a) providing a cooling shell and tube heat exchanger, a heating shell and tube heat exchanger, and a heat transfer fluid to be circulated between the cooling shell and tube heat exchanger and the heating shell and tube heat exchanger; (b) passing a hot gas stream through the cooling shell and tube heat exchanger to heat a liquid heat transfer fluid contained in the cooling shell and tube heat exchanger to form a heat transfer fluid vapor while the hot gas stream is cooled to form a cooled hot gas stream; (c) circulating the heat transfer fluid vapor to the heating shell and tube heat exchanger; (d) passing a wet gas comprising water vapor through the heating shell and tube heat exchanger so that the wet gas is heated to above the dew point and the heat transfer fluid vapor contained in the heating shell and tube heat exchanger is cooled and condensed to form the liquid heat transfer fluid; and (e) circulating the liquid heat transfer fluid from the heating shell and tube heat exchanger to the cooling shell and tube heat exchanger; wherein the cooled hot gas stream exiting from the cooling shell and tube heat exchanger is directed to a wet scrubber to generate the wet gas comprising water vapor.

In some embodiments, the present disclosure provides a process for steam plume suppression. The process comprises (a) providing a cooling shell and tube heat exchanger, a heating shell and tube heat exchanger, and a heat transfer fluid to be circulated on the shell side between the cooling shell and tube heat exchanger and the heating shell and tube heat exchanger; (b) passing a hot gas stream through the tube side of the cooling shell and tube heat exchanger to heat a liquid heat transfer fluid contained on the shell side of the cooling shell and tube heat exchanger to form a heat transfer fluid vapor while the hot gas stream is cooled to form a cooled hot gas stream; (c) circulating the heat transfer fluid vapor to the shell side of the heating shell and tube heat exchanger; (d) passing a wet gas comprising water vapor through the tube side of the heating shell and tube heat exchanger so that the wet gas is heated to above the dew point and the heat transfer fluid vapor contained on the shell side of the heating shell and tube heat exchanger is cooled and condensed to form the liquid heat transfer fluid; and (e) circulating the liquid heat transfer fluid to the shell side of the cooling shell and tube heat exchanger; wherein the cooled hot gas stream exiting from the tube side of the cooling shell and tube heat exchanger is directed to a wet scrubber to generate the wet gas comprising water vapor. The cooling shell and tube heat exchanger and the heating shell and tube heat exchanger are separate heat exchangers. By “separate”, it is meant herein that two heat exchangers have a distance in between and have no sharing parts.

In some embodiments, all or part of the hot gas stream is transferred to the tube side inlet and into the tube side of the cooling shell and tube heat exchanger without intermediate removal of heat. In some embodiments, all or part of the hot gas stream is transferred to the tube side inlet and into the tube side of the cooling shell and tube heat exchanger without passing through an intermediate heat exchanger device.

The hot gas stream exiting from the tube side of the cooling shell and tube heat exchanger is a cooled hot gas stream. In some embodiments, the cooled hot gas stream has a temperature ranging from about 60° C. to about 300° C., or from about 80° C. to about 300° C., or from about 100° C. to about 300° C., or from about 100° C. to about 250° C., or from about 150° C. to about 250° C., or from about 200° C. to about 250° C., or from about 100° C. to about 200° C.

In some embodiments, the cooled hot gas stream has a temperature of no more than 300° C., or no more than 290° C., or no more than 280° C., or no more than 270° C., or no more than 260° C., or no more than 250° C., or no more than 240° C., or no more than 230° C., or no more than 220° C., or no more than 210° C., or no more than 200° C., or no more than 190° C., or no more than 180° C., or no more than 170° C., or no more than 160° C., or no more than 150° C.

In some embodiments, the cooling shell and tube heat exchanger can reduce the temperature of the hot gas stream by about 100° C. to about 400° C., or by about 100° C. to about 300° C., or by about 100° C. to about 200° C. In some embodiments, the cooling shell and tube heat exchanger can reduce the temperature of the hot gas stream by at least 50° C., or at least 60° C., or at least 70° C., or at least 80° C., or at least 90° C., or at least 100° C., or at least 110° C., or at least 120° C., or at least 130° C., or at least 140° C., or at least 150° C., or at least 160° C., or at least 170° C., or at least 180° C., or at least 190° C., or at least 200° C.

In some embodiments, a hot gas stream having a temperature ranging from about 200° C. to about 500° C. is cooled to a temperature ranging from about 100° C. to about 250° C. after passing through the tube side of the cooling shell and tube heat exchanger. In some embodiments, a hot gas stream having a temperature ranging from about 200° C. to about 400° C. is cooled to a temperature ranging from about 100° C. to about 200° C. after passing through the tube side of the cooling shell and tube heat exchanger. In some embodiments, a hot gas stream having a temperature ranging from about 250° C. to about 350° C. is cooled to a temperature ranging from about 150° C. to about 250° C. after passing through the tube side of the cooling shell and tube heat exchanger.

In the cooling shell and tube heat exchanger, heat is transferred from the hot gas stream to the heat transfer fluid which is contained on the shell side and is in liquid state. The liquid heat transfer fluid is at least partially vaporized to form a heat transfer fluid vapor which flows to the shell side of the heating shell and tube heat exchanger.

In the cooling shell and tube heat exchanger, the liquid heat transfer fluid contained on the shell side is heated by the hot gas stream passing through the tube side to form a heat transfer fluid vapor. The operating pressure on the shell side of the cooling or heating shell and tube heat exchanger can be subatmospheric, atmospheric or superatmospheric. In some embodiments, the operating pressures on the shell side of both the cooling shell and tube heat exchanger and the heating shell and tube heat exchanger are superatmospheric. In some embodiments, the operating pressure on the shell side of the cooling shell and tube heat exchanger is substantially same as the operating pressure on the shell side of the heating shell and tube heat exchanger. In some embodiments, the difference of the operating pressure on the shell side between the cooling shell and tube heat exchanger and the heating shell and tube heat exchanger is no more than about 10 psia, or no more than about 5 psia, or no more than about 3 psia, or no more than about 2 psia.

In some embodiments, the operating pressures on the shell side of both the cooling shell and tube heat exchanger and the heating shell and tube heat exchanger range from about 10 to about 2500 psia, or range from about 14 to about 2000 psia, or range from about 14.7 to about 1500 psia, or range from about 14.7 to about 1000 psia, or range from about 14.7 to about 500 psia, or range from about 14.7 to about 200 psia, or range from about 14.7 to about 100 psia, or range from about 14.7 to about 50 psia, or range from about 20 to about 500 psia, or range from about 50 to about 400 psia, or range from about 100 to about 250 psia, or range from about 200 to about 300 psia.

In some embodiments, the liquid heat transfer fluid contained on the shell side of the cooling shell and tube heat exchanger is heated to substantially its boiling point. In some embodiments, the liquid heat transfer fluid is heated to a temperature which is within a range of ±20° C., or 15° C., or ±10° C., or ±5° C. of its boiling point under the operating pressure on the shell side of the cooling shell and tube heat exchanger. The resulting heat transfer fluid vapor flows to the shell side of the heating shell and tube heat exchanger.

In some embodiments, the heat transfer fluid vapor flows from the shell side outlet of the cooling shell and tube heat exchanger into the shell side inlet of the heating shell and tube heat exchanger without intermediate removal of heat or intermediate addition of heat from the heat transfer fluid vapor. In some embodiments, the heat transfer fluid vapor flows from the shell side outlet of the cooling shell and tube heat exchanger into the shell side inlet of the heating shell and tube heat exchanger without passing through an intermediate heat exchanger device between the shell side outlet of the cooling shell and tube heat exchanger and the shell side inlet of the heating shell and tube heat exchanger.

The wet gas flows from the scrubbed gas outlet into the tube side inlet of the heating shell and tube heat exchanger. In some embodiments, the wet gas is transferred from the scrubbed gas outlet into the tube side of the heating shell and tube heat exchanger without intermediate removal of heat or intermediate addition of heat. In some embodiments, the wet gas is transferred into the tube side of the heating shell and tube heat exchanger without passing through an intermediate heat exchanger device between the scrubbed gas outlet and the tube side inlet of the heating shell and tube heat exchanger.

In some embodiments, the wet gas is transferred from the scrubbed gas outlet into the tube side of the heating shell and tube heat exchanger without addition of other gases (e.g., air) into the wet gas. In some embodiments, the wet gas at the scrubbed gas outlet has substantially the same amount of water vapor content as the wet gas at the tube side inlet of the heating shell and tube heat exchanger.

In the heating shell and tube heat exchanger, the wet gas is heated by the heat transfer fluid vapor to above the dew point to form a heated wet gas. As a result of the heat transfer, the heat transfer fluid vapor is cooled and condensed on the shell side to form the liquid heat transfer fluid.

In some embodiments, the heated wet gas exiting the tube side outlet of the heating shell and tube heat exchanger is discharged directly into the atmosphere without further treatment or purification. In some embodiments, the heated wet gas exiting the tube side outlet of the heating shell and tube heat exchanger is discharged directly into the atmosphere without passing through another heat exchanger device. In some embodiments, the heated wet gas exiting the tube side outlet of the heating shell and tube heat exchanger is discharged directly into the atmosphere without addition of other gases (e.g., air or heated air) into the heated wet gas.

The liquid heat transfer fluid formed on the shell side of the heating shell and tube heat exchanger circulates back to the shell side of the cooling shell and tube heat exchanger to cool the hot gas stream.

In some embodiments, the present disclosure provides a process for steam plume suppression. The process comprises (a) providing a cooling shell and tube heat exchanger, a heating shell and tube heat exchanger, and a heat transfer fluid to be circulated on the tube side between the cooling shell and tube heat exchanger and the heating shell and tube heat exchanger; (b) passing a hot gas stream through the shell side of the cooling shell and tube heat exchanger to heat a liquid heat transfer fluid contained on the tube side of the cooling shell and tube heat exchanger to form a heat transfer fluid vapor while the hot gas stream is cooled to form a cooled hot gas stream; (c) circulating the heat transfer fluid vapor to the tube side of the heating shell and tube heat exchanger (d) passing a wet gas comprising water vapor through the shell side of the heating shell and tube heat exchanger so that the wet gas is heated to above the dew point and the heat transfer fluid vapor contained on the tube side of the heating shell and tube heat exchanger is cooled and condensed to form the liquid heat transfer fluid; and (e) circulating the liquid heat transfer fluid to the tube side of the cooling shell and tube heat exchanger; wherein the cooled hot gas stream exiting from the shell side of the cooling shell and tube heat exchanger is directed to a wet scrubber to generate the wet gas comprising water vapor. The cooling shell and tube heat exchanger and the heating shell and tube heat exchanger are separate heat exchangers.

In some embodiments, all or part of the hot gas stream is transferred to the shell side inlet and into the shell side of the cooling shell and tube heat exchanger without intermediate removal of heat. In some embodiments, all or part of the hot gas stream is transferred to the shell side inlet and into the shell side of the cooling shell and tube heat exchanger without passing through an intermediate heat exchanger device.

The hot gas stream exiting from the shell side of the cooling shell and tube heat exchanger is a cooled hot gas stream. In some embodiments, the cooled hot gas stream has a temperature ranging from about 60° C. to about 300° C., or from about 80° C. to about 300° C., or from about 100° C. to about 300° C., or from about 100° C. to about 250° C., or from about 150° C. to about 250° C., or from about 200° C. to about 250° C., or from about 100° C. to about 200° C. In some embodiments, the cooled hot gas stream has a temperature of no more than 300° C., or no more than 290° C., or no more than 280° C., or no more than 270° C., or no more than 260° C., or no more than 250° C., or no more than 240° C., or no more than 230° C., or no more than 220° C., or no more than 210° C., or no more than 200° C., or no more than 190° C., or no more than 180° C., or no more than 170° C., or no more than 160° C., or no more than 150° C.

In some embodiments, the cooling shell and tube heat exchanger can reduce the temperature of the hot gas stream by about 100° C. to about 400° C., or by about 100° C. to about 300° C., or by about 100° C. to about 200° C. In some embodiments, the cooling shell and tube heat exchanger can reduce the temperature of the hot gas stream by at least 50° C., or at least 60° C., or at least 70° C., or at least 80° C., or at least 90° C., or at least 100° C., or at least 110° C., or at least 120° C., or at least 130° C., or at least 140° C., or at least 150° C., or at least 160° C., or at least 170° C., or at least 180° C., or at least 190° C., or at least 200° C.

In some embodiments, a hot gas stream having a temperature ranging from about 200° C. to about 500° C. is cooled to a temperature ranging from about 100° C. to about 250° C. after passing through the shell side of the cooling shell and tube heat exchanger. In some embodiments, a hot gas stream having a temperature ranging from about 200° C. to about 400° C. is cooled to a temperature ranging from about 100° C. to about 200° C. after passing through the shell side of the cooling shell and tube heat exchanger. In some embodiments, a hot gas stream having a temperature ranging from about 250° C. to about 350° C. is cooled to a temperature ranging from about 150° C. to about 250° C. after passing through the shell side of the cooling shell and tube heat exchanger.

In the cooling shell and tube heat exchanger, heat is transferred from the hot gas stream to the heat transfer fluid which is contained on the tube side and is in liquid state. The liquid heat transfer fluid is at least partially vaporized to form a heat transfer fluid vapor which flows to the tube side of the heating shell and tube heat exchanger.

In the cooling shell and tube heat exchanger, the liquid heat transfer fluid contained on the tube side is heated by the hot gas stream passing through the shell side to form a heat transfer fluid vapor. The operating pressure on the tube side of the cooling or heating shell and tube heat exchanger can be subatmospheric, atmospheric or superatmospheric. In some embodiments, the operating pressures on the tube side of both the cooling shell and tube heat exchanger and the heating shell and tube heat exchanger are superatmospheric. In some embodiments, the operating pressure on the tube side of the cooling shell and tube heat exchanger is substantially same as the operating pressure on the tube side of the heating shell and tube heat exchanger. In some embodiments, the difference of the operating pressure on the tube side between the cooling shell and tube heat exchanger and the heating shell and tube heat exchanger is no more than about 10 psia, or no more than about 5 psia, or no more than about 3 psia, or no more than about 2 psia.

In some embodiments, the operating pressures on the tube side of both the cooling shell and tube heat exchanger and the heating shell and tube heat exchanger range from about 10 to about 2500 psia, or range from about 14 to about 2000 psia, or range from about 14.7 to about 1500 psia, or range from about 14.7 to about 1000 psia, or range from about 14.7 to about 500 psia, or range from about 14.7 to about 200 psia, or range from about 14.7 to about 100 psia, or range from about 14.7 to about 50 psia, or range from about 20 to about 500 psia, or range from about 50 to about 400 psia, or range from about 100 to about 250 psia, or range from about 200 to about 300 psia.

In some embodiments, the liquid heat transfer fluid contained on the tube side of the cooling shell and tube heat exchanger is heated to substantially its boiling point. In some embodiments, the liquid heat transfer fluid is heated to a temperature which is within a range of ±20° C., or 15° C., or ±10° C., or ±5° C. of its boiling point under the operating pressure on the tube side of the cooling shell and tube heat exchanger. The resulting heat transfer fluid vapor flows to the tube side of the heating shell and tube heat exchanger.

In some embodiments, the heat transfer fluid vapor flows from the tube side outlet of the cooling shell and tube heat exchanger into the tube side inlet of the heating shell and tube heat exchanger without intermediate removal of heat or intermediate addition of heat from the heat transfer fluid vapor. In some embodiments, the heat transfer fluid vapor flows from the tube side outlet of the cooling shell and tube heat exchanger into the tube side inlet of the heating shell and tube heat exchanger without passing through an intermediate heat exchanger device between the tube side outlet of the cooling shell and tube heat exchanger and the tube side inlet of the heating shell and tube heat exchanger.

The wet gas flows from the scrubbed gas outlet into the shell side inlet of the heating shell and tube heat exchanger. In some embodiments, the wet gas is transferred from the scrubbed gas outlet into the shell side of the heating shell and tube heat exchanger without intermediate removal of heat or intermediate addition of heat. In some embodiments, the wet gas is transferred into the shell side of the heating shell and tube heat exchanger without passing through an intermediate heat exchanger device between the scrubbed gas outlet and the shell side inlet of the heating shell and tube heat exchanger.

In some embodiments, the wet gas is transferred from the scrubbed gas outlet into the shell side of the heating shell and tube heat exchanger without addition of other gases (e.g., air) into the wet gas. In some embodiments, the wet gas at the scrubbed gas outlet has substantially the same amount of water vapor content as the wet gas at the shell side inlet of the heating shell and tube heat exchanger.

In the heating shell and tube heat exchanger, the wet gas is heated by the heat transfer fluid vapor to above the dew point to form a heated wet gas. As a result of the heat transfer, the heat transfer fluid vapor is cooled and condensed on the tube side to form the liquid heat transfer fluid.

In some embodiments, the heated wet gas exiting the shell side outlet of the heating shell and tube heat exchanger is discharged directly into the atmosphere without further treatment or purification. In some embodiments, the heated wet gas exiting the shell side outlet of the heating shell and tube heat exchanger is discharged directly into the atmosphere without passing through another heat exchanger device. In some embodiments, the heated wet gas exiting the shell side outlet of the heating shell and tube heat exchanger is discharged directly into the atmosphere without addition of other gases (e.g., air or heated air) into the heated wet gas.

The liquid heat transfer fluid formed on the tube side of the heating shell and tube heat exchanger circulates back to the tube side of the cooling shell and tube heat exchanger to cool the hot gas stream.

The present disclosure also provides a steam plume suppression system. The system comprises (a) a cooling shell and tube heat exchanger comprising a shell side inlet, a shell side outlet, a tube side inlet and a tube side outlet; (b) a heating shell and tube heat exchanger comprising a shell side inlet, a shell side outlet, a tube side inlet and a tube side outlet; and (c) a wet scrubber comprising a gas inlet and a scrubbed gas outlet; wherein the tube side outlet of the cooling shell and tube heat exchanger is connected with the gas inlet of the wet scrubber, the scrubbed gas outlet of the wet scrubber is connected with the tube side inlet of the heating shell and tube heat exchanger, the shell side outlet of the cooling shell and tube heat exchanger is connected with the shell side inlet of the heating shell and tube heat exchanger, and the shell side outlet of the heating shell and tube heat exchanger is connected with the shell side inlet of the cooling shell and tube heat exchanger. The cooling shell and tube heat exchanger and the heating shell and tube heat exchanger are separate heat exchangers.

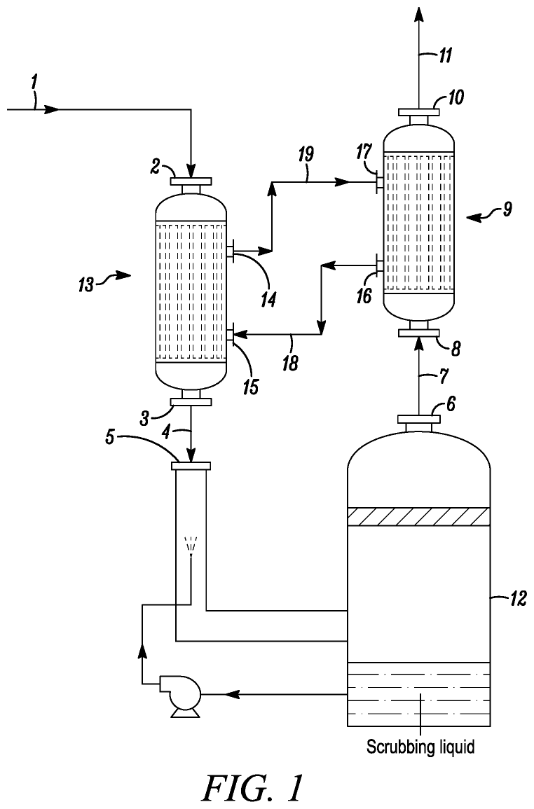

For the purposes of illustration and better understanding of the present invention, and in accordance with certain preferred embodiments, the present invention will be described with reference to the steam plume suppression system shown schematically in FIG. 1.

The steam plume suppression system comprises a cooling shell and tube heat exchanger 13, a heating shell and tube heat exchanger 9, and a wet scrubber 12. The cooling shell and tube heat exchanger 13 comprises a shell side inlet 15, a shell side outlet 14, a tube side inlet 2 and a tube side outlet 3. The heating shell and tube heat exchanger 9 comprises a shell side inlet 17, a shell side outlet 16, a tube side inlet 8 and a tube side outlet 10. The wet scrubber 12 comprises a gas inlet 5 and a scrubbed gas outlet 6.

A hot gas stream 1 is introduced into the cooling shell and tube heat exchanger 13 through the tube side inlet 2. In some embodiments, the tube side inlet 2 is fluidly connected with an exhaust pipe from a combustion or refinery unit (e.g., FCCU or SRU) for transferring the hot gas stream. The tube side outlet 3 is configured for connection in fluid communication with the gas inlet 5 of the wet scrubber 12 for delivering the cooled hot gas stream 4 from the cooling shell and tube heat exchanger 13 into the wet scrubber 12. In some embodiments, the tube side outlet 3 is directly connected to the gas inlet 5. The cooled hot gas stream 4 is introduced into the wet scrubber 12 through the gas inlet 5. The cooled hot gas stream 4 is scrubbed, cleaned and substantially saturated with water vapor in the wet scrubber 12 and leaves the wet scrubber 12 as a wet gas 7 through the scrubbed gas outlet 6.

The scrubbed gas outlet 6 is configured for connection in fluid communication with the tube side inlet 8 for delivering the wet gas 7 from the wet scrubber 12 into the heating shell and tube heat exchanger 9. In some embodiments, the scrubbed gas outlet 6 is directly connected to the tube side inlet 8. The wet gas 7 is introduced into the heating shell and tube heat exchanger 9 through the tube side inlet 8 and leaves the heat exchanger 9 as a heated wet gas 11 through the tube side outlet 10. In some embodiments, the tube side outlet 10 may be fluidly connected to a discharge stack (not shown) for release of the heated wet gas 11 to the atmosphere. In some embodiments, the tube side outlet 10 is directly connected to a discharge stack.

The shell side outlet 14 of the cooling shell and tube heat exchanger 13 is fluidly connected with the shell side inlet 17 of the heating shell and tube heat exchanger 9, and the shell side outlet 16 of the heating shell and tube heat exchanger 9 is fluidly connected with the shell side inlet 15 of the cooling shell and tube heat exchanger 13. In some embodiments, the shell side outlet 14 is directly connected with the shell side inlet 17, and the shell side outlet 16 is directly connected with the shell side inlet 15. With such configuration, the cooling shell and tube heat exchanger 13 and a heating shell and tube heat exchanger 9 are connected to form a thermosyphon system. The liquid heat transfer fluid contained on the shell side of the cooling shell and tube heat exchanger 13 is heated and evaporated to form a heat transfer fluid vapor 19 which flows into the heating shell and tube heat exchanger 9 through the shell side inlet 17. The heat transfer fluid vapor is cooled and condensed on the shell side of the heating shell and tube heat exchanger 9 to form a liquid heat transfer fluid 18 which is circulated back into the cooling shell and tube heat exchanger 13 through the shell side inlet 15. No pump is used to circulate or transfer the heat transfer fluid between the cooling and heating shell and tube heat exchangers.

In some embodiments, the shell side outlet 16 is at a higher elevation than the shell side inlet 15. In some embodiments, the shell side inlet 17 is at a higher elevation than the shell side outlet 14. In some embodiments, the heating shell and tube heat exchanger 9 is at a higher elevation than the cooling shell and tube heat exchanger 13.

In some embodiments, the heating shell and tube heat exchanger 9 and/or the cooling shell and tube heat exchanger 13 has static mixing structure on the shell side to generate turbulence. In some embodiments, the heating shell and tube heat exchanger 9 and/or the cooling shell and tube heat exchanger 13 has static mixing structure on the tube side to generate turbulence. In some embodiments, the heating shell and tube heat exchanger 9 and/or the cooling shell and tube heat exchanger 13 has no static mixing structure on the shell side to generate turbulence. In some embodiments, the heating shell and tube heat exchanger 9 and/or the cooling shell and tube heat exchanger 13 has no static mixing structure on the tube side to generate turbulence.

The present disclosure further provides a process for steam plume suppression. The process comprises (a) providing an integrated shell and tube heat exchanger comprising a shell, a plurality of tubes, and a substantially horizontal tube sheet sealingly engaging the tubes and an interior wall of the shell and defining an upper chamber and a lower chamber within the integrated shell and tube heat exchanger, wherein the plurality of tubes extend upwardly from the lower chamber to the upper chamber; (b) providing a heat transfer fluid to be circulated on the tube side between the lower chamber and the upper chamber (c) passing a hot gas stream through the shell side of the lower chamber to heat a liquid heat transfer fluid contained on the tube side of the lower chamber to form a heat transfer fluid vapor which rises to the tube side of the upper chamber while the hot gas stream is cooled to form a cooled hot gas stream; and (d) passing a wet gas comprising water vapor through the shell side of the upper chamber so that the wet gas is heated to above the dew point and the heat transfer fluid vapor contained on the tube side of the upper chamber is cooled and condensed to form the liquid heat transfer fluid which is circulated to the tube side of the lower chamber wherein the cooled hot gas stream exiting from the shell side of the lower chamber is directed to a wet scrubber to generate the wet gas comprising water vapor.

The integrated shell and tube heat exchanger comprises a shell having an interior wall and an exterior wall. The integrated shell and tube heat exchanger also comprises a plurality of tubes. In some embodiments, the plurality of tubes are separate and independent and unconnected with each other. In such embodiments, each tube has two ends, and both ends are sealed. In some embodiments, two or more tubes are fluidly connected, and the ends are sealed. In some embodiments, all tubes are fluidly connected to form a single tube unit. The unit has two ends which are both sealed. In some embodiments, the plurality of tubes are substantially vertical.

The integrated shell and tube heat exchanger further comprises a tube sheet extending generally horizontally through the shell and dividing the shell into two chambers: an upper chamber and a lower chamber. The substantially horizontal tube sheet sealingly engages the tubes and the interior wall of the shell and defines the upper chamber and the lower chamber inside the shell of the integrated shell and tube heat exchanger. The tube sheet is gas-impermeable. The lower chamber is under the upper chamber. Each of the plurality of tubes extends substantially vertically from one chamber to the other. The heat transfer fluid is contained in the tubes and circulates on the tube side between the lower chamber and the upper chamber during the operation. The upper chamber and the lower chamber each has a shell side inlet and a shell side outlet respectively. In some embodiments, the volume of the upper chamber and the volume of the lower chamber are substantially equal.

All or part of the hot gas stream is introduced into the shell side inlet of the lower chamber and passes through the shell side of the lower chamber to heat a liquid heat transfer fluid contained on the tube side of the lower chamber to form a heat transfer fluid vapor which rises to the tube side of the upper chamber. In some embodiments, all or part of the hot gas stream is transferred to the shell side inlet of the lower chamber without intermediate removal of heat. In some embodiments, all or part of the hot gas stream is transferred to the shell side inlet of the lower chamber without passing through an intermediate heat exchanger device.

The hot gas stream exiting from the shell side outlet of the lower chamber is a cooled hot gas stream. In some embodiments, the cooled hot gas stream has a temperature ranging from about 60° C. to about 300° C., or from about 80° C. to about 300° C., or from about 100° C. to about 300° C., or from about 100° C. to about 250° C., or from about 150° C. to about 250° C., or from about 200° C. to about 250° C., or from about 100° C. to about 200° C. In some embodiments, the cooled hot gas stream has a temperature of no more than 300° C., or no more than 290° C., or no more than 280° C., or no more than 270° C., or no more than 260° C., or no more than 250° C., or no more than 240° C., or no more than 230° C., or no more than 220° C., or no more than 210° C., or no more than 200° C., or no more than 190° C., or no more than 180° C., or no more than 170° C., or no more than 160° C., or no more than 150° C.

In some embodiments, the lower chamber can reduce the temperature of the hot gas stream by about 100° C. to about 400° C., or by about 100° C. to about 300° C., or by about 100° C. to about 200° C. In some embodiments, the lower chamber can reduce the temperature of the hot gas stream by at least 50° C., or at least 60° C., or at least 70° C., or at least 80° C., or at least 90° C., or at least 100° C., or at least 110° C., or at least 120° C., or at least 130° C., or at least 140° C., or at least 150° C., or at least 160° C., or at least 170° C., or at least 180° C., or at least 190° C., or at least 200° C.

In some embodiments, a hot gas stream having a temperature ranging from about 200° C. to about 500° C. is cooled to a temperature ranging from about 100° C. to about 250° C. after passing through the shell side of the lower chamber. In some embodiments, a hot gas stream having a temperature ranging from about 200° C. to about 400° C. is cooled to a temperature ranging from about 100° C. to about 200° C. after passing through the shell side of the lower chamber. In some embodiments, a hot gas stream having a temperature ranging from about 250° C. to about 350° C. is cooled to a temperature ranging from about 150° C. to about 250° C. after passing through the shell side of the lower chamber.

The operating pressure on the tube side of the integrated shell and tube heat exchanger can be subatmospheric, atmospheric or superatmospheric. In some embodiments, the operating pressure on the tube side of the integrated shell and tube heat exchanger is superatmospheric. In some embodiments, the operating pressure on the tube side of the integrated shell and tube heat exchanger ranges from about 10 to about 2500 psia, or ranges from about 14 to about 2000 psia, or ranges from about 14.7 to about 1500 psia, or ranges from about 14.7 to about 1000 psia, or ranges from about 14.7 to about 500 psia, or ranges from about 14.7 to about 200 psia, or ranges from about 14.7 to about 100 psia, or ranges from about 14.7 to about 50 psia, or ranges from about 20 to about 500 psia, or ranges from about 50 to about 400 psia, or ranges from about 100 to about 250 psia, or ranges from about 200 to about 300 psia.

In some embodiments, the liquid heat transfer fluid contained on the tube side of the lower chamber is heated to substantially its boiling point. In some embodiments, the liquid heat transfer fluid is heated to a temperature which is within a range of ±15° C., or ±10° C., or ±5° C. of its boiling point under the operating pressure of the tube side of the integrated shell and tube heat exchanger. The resulting heat transfer fluid vapor rises to the tube side of the upper chamber.

The lower chamber is used herein to reduce the temperature of the hot gas stream before it is introduced into a wet scrubber. The cooled hot gas stream is directed to a wet scrubber so that the particulate and gaseous impurities contained therein can be removed. In some embodiments, the cooled hot gas stream is transferred to the gas inlet of the wet scrubber without intermediate removal of heat or intermediate addition of heat. In some embodiments, the cooled hot gas stream is transferred into the gas inlet of the wet scrubber without passing through an intermediate heat exchanger device between the shell side outlet of the lower chamber and the gas inlet of the wet scrubber.

The wet gas flows from the scrubbed gas outlet into the shell side inlet of the upper chamber. In some embodiments, the wet gas is transferred from the scrubbed gas outlet into the shell side inlet of the upper chamber without intermediate removal of heat or intermediate addition of heat. In some embodiments, the wet gas is transferred into the shell side inlet of the upper chamber without passing through an intermediate heat exchanger device between the scrubbed gas outlet and the shell side inlet of the upper chamber.

In some embodiments, the wet gas is transferred from the scrubbed gas outlet into the shell side of the upper chamber without addition of other gases (e.g., air) into the wet gas. In some embodiments, the wet gas at the scrubbed gas outlet has substantially the same amount of water vapor content as the wet gas at the shell side inlet of the upper chamber.

As the wet gas comprising water vapor passes through the shell side of the upper chamber, the wet gas is heated to above the dew point and the heat transfer fluid vapor contained on the tube side of the upper chamber is cooled and condensed to form the liquid heat transfer fluid which sinks and circulates back to the tube side of the lower chamber to cool the hot gas stream.

In the upper chamber of the integrated shell and tube heat exchanger, the wet gas is heated by the heat transfer fluid vapor to above the dew point to form a heated wet gas. As a result of the heat transfer, the heat transfer fluid vapor is cooled and condensed on the tube side of the upper chamber to form the liquid heat transfer fluid. In some embodiments, the heated wet gas exiting the shell side outlet of the upper chamber is discharged directly into the atmosphere without further treatment or purification. In some embodiments, the heated wet gas exiting the shell side outlet of the upper chamber is discharged directly into the atmosphere without passing through another heat exchanger device. In some embodiments, the heated wet gas exiting the shell side outlet of the upper chamber is discharged directly into the atmosphere without addition of other gases (e.g., air or heated air) into the heated wet gas.

The present disclosure further provides a steam plume suppression system. The system comprises: (a) an integrated shell and tube heat exchanger comprising a shell, a plurality of tubes, and a substantially horizontal tube sheet sealingly engaging the tubes and an interior wall of the shell and defining an upper chamber and a lower chamber within the integrated shell and tube heat exchanger, wherein the plurality of tubes extend upwardly from the lower chamber to the upper chamber, and the upper chamber and the lower chamber each has a shell side inlet and a shell side outlet; and (b) a wet scrubber comprising a gas inlet and a scrubbed gas outlet; wherein the shell side outlet of the lower chamber is connected with the gas inlet of the wet scrubber, and the scrubbed gas outlet of the wet scrubber is connected with the shell side inlet of the upper chamber. In some embodiments, the plurality of tubes are substantially vertical.

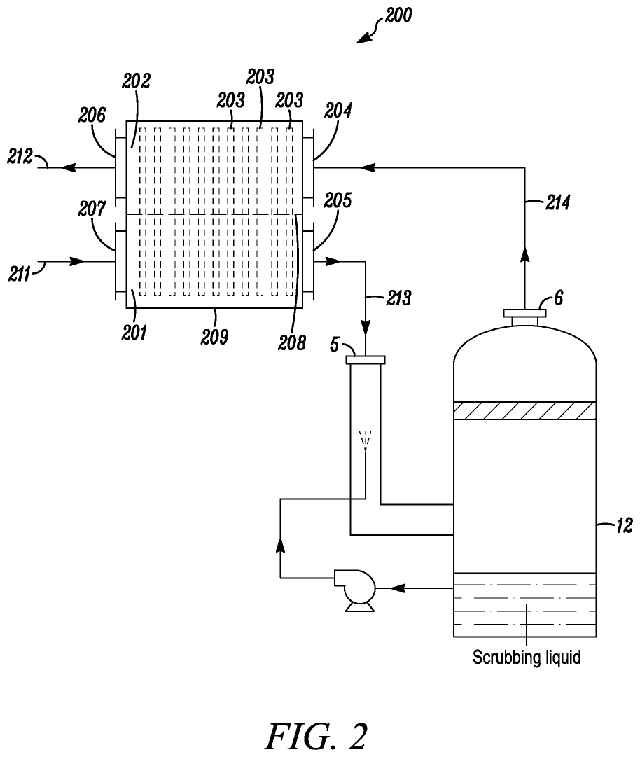

For the purposes of illustration and better understanding of the present invention, and in accordance with certain preferred embodiments, the present invention will be described with reference to the steam plume suppression system shown schematically in FIG. 2.

The steam plume suppression system comprises an integrated shell and tube heat exchanger 200 and a wet scrubber 12. The integrated shell and tube heat exchanger 200 comprises a shell 209, a plurality of tubes 203, and a substantially horizontal tube sheet 208 sealingly engaging the tubes 203 and an interior wall of the shell and defining an upper chamber 202 and a lower chamber 201 within the integrated shell and tube heat exchanger 200, wherein the plurality of tubes 203 extend upwardly from the lower chamber 201 to the upper chamber 202. The upper chamber 202 has a shell side inlet 204 and a shell side outlet 206. The lower chamber 201 has a shell side inlet 207 and a shell side outlet 205. The wet scrubber 12 comprises a gas inlet 5 and a scrubbed gas outlet 6.

A hot gas stream 211 is introduced into the lower chamber 201 of the integrated shell and tube heat exchanger 200 through the shell side inlet 207. In some embodiments, the shell side inlet 207 is fluidly connected with an exhaust pipe from a combustion or refinery unit (e.g., FCCU or SRU) for transferring the hot gas stream. The shell side outlet 205 is configured for connection in fluid communication with the gas inlet 5 of the wet scrubber 12 for delivering the cooled hot gas stream 213 from the lower chamber 201 into the wet scrubber 12. In some embodiments, the shell side outlet 205 is directly connected to the gas inlet 5. The cooled hot gas stream 213 is introduced into the wet scrubber 12 through the gas inlet 5. The cooled hot gas stream 213 is scrubbed, cleaned and substantially saturated with water vapor in the wet scrubber 12 and leaves the wet scrubber 12 as a wet gas 214 through the scrubbed gas outlet 6.

The scrubbed gas outlet 6 is configured for connection in fluid communication with the shell side inlet 204 of the upper chamber 202 for delivering the wet gas 214 from the wet scrubber 12 into the shell side of the upper chamber 202. In some embodiments, the scrubbed gas outlet 6 is directly connected to the shell side inlet 204. The wet gas 214 is introduced into the shell side of the upper chamber 202 through the shell side inlet 204 and leaves the upper chamber 202 as a heated wet gas 212 through the shell side outlet 206. In some embodiments, the shell side outlet 206 may be fluidly connected to a discharge stack (not shown) for release of the heated wet gas 212 to the atmosphere. In some embodiments, the shell side outlet 206 is directly connected to a discharge stack.

In some embodiments, the upper chamber 202 and/or the lower chamber 201 has static mixing structure on the shell side to generate turbulence. In some embodiments, the upper chamber 202 and/or the lower chamber 201 has static mixing structure on the tube side to generate turbulence. In some embodiments, the upper chamber 202 and/or the lower chamber 201 has no static mixing structure on the shell side to generate turbulence. In some embodiments, the upper chamber 202 and/or the lower chamber 201 has no static mixing structure on the tube side to generate turbulence.

The present disclosure further provides a steam plume suppression system. The system comprises: (a) a cooling shell and tube heat exchanger comprising a shell side inlet, a shell side outlet, a tube side inlet and a tube side outlet; (b) a heating shell and tube heat exchanger comprising a shell side inlet, a shell side outlet, a tube side inlet and a tube side outlet; and (c) a wet scrubber comprising a gas inlet and a scrubbed gas outlet; wherein the shell side outlet of the cooling shell and tube heat exchanger is connected with the gas inlet of the wet scrubber, the scrubbed gas outlet of the wet scrubber is connected with the shell side inlet of the heating shell and tube heat exchanger, the tube side outlet of the cooling shell and tube heat exchanger is connected with the tube side inlet of the heating shell and tube heat exchanger, and the tube side outlet of the heating shell and tube heat exchanger is connected with the tube side inlet of the cooling shell and tube heat exchanger. The cooling shell and tube heat exchanger and the heating shell and tube heat exchanger are separate heat exchangers.

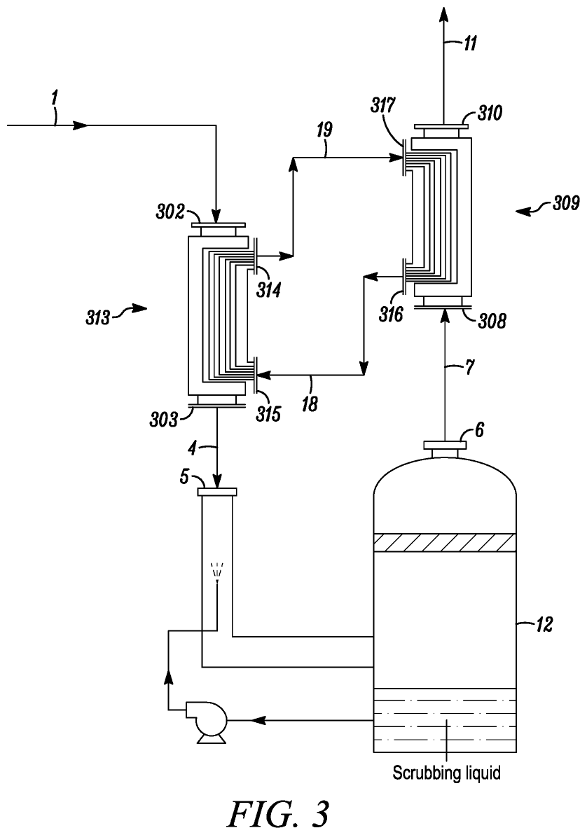

For the purposes of illustration and better understanding of the present invention, and in accordance with certain preferred embodiments, the present invention will be described with reference to the steam plume suppression system shown schematically in FIG. 3.

The steam plume suppression system comprises a cooling shell and tube heat exchanger 313, a heating shell and tube heat exchanger 309, and a wet scrubber 12. The cooling shell and tube heat exchanger 313 comprises a shell side inlet 302, a shell side outlet 303, a tube side inlet 315 and a tube side outlet 314. The heating shell and tube heat exchanger 309 comprises a shell side inlet 308, a shell side outlet 310, a tube side inlet 317 and a tube side outlet 316. The wet scrubber 12 comprises a gas inlet 5 and a scrubbed gas outlet 6.

A hot gas stream 1 is introduced into the cooling shell and tube heat exchanger 313 through the shell side inlet 302. In some embodiments, the shell side inlet 302 is fluidly connected with an exhaust pipe from a combustion or refinery unit (e.g., FCCU or SRU) for transferring the hot gas stream. The shell side outlet 303 is configured for connection in fluid communication with the gas inlet 5 of the wet scrubber 12 for delivering the cooled hot gas stream 4 from the cooling shell and tube heat exchanger 313 into the wet scrubber 12. In some embodiments, the shell side outlet 303 is directly connected to the gas inlet. The cooled hot gas stream 4 is introduced into the wet scrubber 12 through the gas inlet 5. The cooled hot gas stream 4 is scrubbed, cleaned and substantially saturated with water vapor in the wet scrubber 12 and leaves the wet scrubber 12 as a wet gas 7 through the scrubbed gas outlet 6.

The scrubbed gas outlet 6 is configured for connection in fluid communication with the shell side inlet 308 for delivering the wet gas 7 from the wet scrubber 12 into the heating shell and tube heat exchanger 309. In some embodiments, the scrubbed gas outlet 6 is directly connected to the shell side inlet 308. The wet gas 7 is introduced into the heating shell and tube heat exchanger 309 through the shell side inlet 308 and leaves the heat exchanger 309 as a heated wet gas 11 through the shell side outlet 310. In some embodiments, the shell side outlet 310 may be fluidly connected to a discharge stack (not shown) for release of the heated wet gas 11 to the atmosphere. In some embodiments, the shell side outlet 310 is directly connected to a discharge stack.

The tube side outlet 314 of the cooling shell and tube heat exchanger 313 is fluidly connected with the tube side inlet 317 of the heating shell and tube heat exchanger 309, and the tube side outlet 316 of the heating shell and tube heat exchanger 309 is fluidly connected with the tube side inlet 315 of the cooling shell and tube heat exchanger 313. In some embodiments, the tube side outlet 314 is directly connected with the tube side inlet 317, and the tube side outlet 316 is directly connected with the tube side inlet 315. With such configuration, the cooling shell and tube heat exchanger 313 and the heating shell and tube heat exchanger 309 are connected to form a thermosyphon system. The liquid heat transfer fluid contained on the tube side of the cooling shell and tube heat exchanger 313 is heated and evaporated to form a heat transfer fluid vapor 19 which flows into the heating shell and tube heat exchanger 309 through the tube side inlet 317. The heat transfer fluid vapor is cooled and condensed on the tube side of the heating shell and tube heat exchanger 309 to form a liquid heat transfer fluid 18 which is circulated back into the cooling shell and tube heat exchanger 313 through the tube side inlet 315. No pump is used to circulate or transfer the heat transfer fluid between the cooling and heating shell and tube heat exchangers.

In some embodiments, the tube side outlet 316 is at a higher elevation than the tube side inlet 315. In some embodiments, the tube side inlet 317 is at a higher elevation than the tube side outlet 314. In some embodiments, the heating shell and tube heat exchanger 309 is at a higher elevation than the cooling shell and tube heat exchanger 313.

In some embodiments, the heating shell and tube heat exchanger 309 and/or the cooling shell and tube heat exchanger 313 has static mixing structure on the shell side to generate turbulence. In some embodiments, the heating shell and tube heat exchanger 309 and/or the cooling shell and tube heat exchanger 313 has static mixing structure on the tube side to generate turbulence. In some embodiments, the heating shell and tube heat exchanger 309 and/or the cooling shell and tube heat exchanger 313 has no static mixing structure on the shell side to generate turbulence. In some embodiments, the heating shell and tube heat exchanger 309 and/or the cooling shell and tube heat exchanger 313 has no static mixing structure on the tube side to generate turbulence.

In the foregoing specification, the concepts have been described with reference to specific embodiments. However, one of ordinary skill in the art appreciates that various modifications and changes can be made without departing from the scope of the invention as set forth in the claims below. Accordingly, the specification is to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

It is to be appreciated that certain features are, for clarity, described herein in the context of separate embodiments, may also be provided in combination in a single embodiment. Conversely, various features that are, for brevity, described in the context of a single embodiment, may also be provided separately or in any subcombination.

### Embodiments

For further illustration, additional non-limiting embodiments of the present disclosure are set forth below.

For example, embodiment 1 is a process for steam plume suppression, comprising: (a) providing a cooling shell and tube heat exchanger, a heating shell and tube heat exchanger, and a heat transfer fluid to be circulated on the shell side between the cooling shell and tube heat exchanger and the heating shell and tube heat exchanger; (b) passing a hot gas stream through the tube side of the cooling shell and tube heat exchanger to heat a liquid heat transfer fluid contained on the shell side of the cooling shell and tube heat exchanger to form a heat transfer fluid vapor while the hot gas stream is cooled to form a cooled hot gas stream; (c) circulating the heat transfer fluid vapor to the shell side of the heating shell and tube heat exchanger; (d) passing a wet gas comprising water vapor through the tube side of the heating shell and tube heat exchanger so that the wet gas is heated to above the dew point and the heat transfer fluid vapor contained on the shell side of the heating shell and tube heat exchanger is cooled and condensed to form the liquid heat transfer fluid; and (e) circulating the liquid heat transfer fluid to the shell side of the cooling shell and tube heat exchanger; wherein the cooled hot gas stream exiting from the tube side of the cooling shell and tube heat exchanger is directed to a wet scrubber to generate the wet gas comprising water vapor.

Embodiment 2 is a process for steam plume suppression, comprising: (a) providing a cooling shell and tube heat exchanger, a heating shell and tube heat exchanger, and a heat transfer fluid to be circulated on the tube side between the cooling shell and tube heat exchanger and the heating shell and tube heat exchanger; (b) passing a hot gas stream through the shell side of the cooling shell and tube heat exchanger to heat a liquid heat transfer fluid contained on the tube side of the cooling shell and tube heat exchanger to form a heat transfer fluid vapor while the hot gas stream is cooled to form a cooled hot gas stream; (c) circulating the heat transfer fluid vapor to the tube side of the heating shell and tube heat exchanger; (d) passing a wet gas comprising water vapor through the shell side of the heating shell and tube heat exchanger so that the wet gas is heated to above the dew point and the heat transfer fluid vapor contained on the tube side of the heating shell and tube heat exchanger is cooled and condensed to form the liquid heat transfer fluid; and (e) circulating the liquid heat transfer fluid to the tube side of the cooling shell and tube heat exchanger; wherein the cooled hot gas stream exiting from the shell side of the cooling shell and tube heat exchanger is directed to a wet scrubber to generate the wet gas comprising water vapor.

Embodiment 3 is a process for steam plume suppression as set forth in one of embodiments 1-2, wherein the heat transfer fluid consists essentially of water.

Embodiment 4 is a process for steam plume suppression as set forth in one of embodiments 1-2, wherein no pump is used to circulate the heat transfer fluid.

Embodiment 5 is a process for steam plume suppression as set forth in one of embodiments 1-2, wherein the wet gas is substantially saturated with water vapor.

Embodiment 6 is a process for steam plume suppression as set forth in one of embodiments 1-2, wherein the wet gas is heated to a temperature at least about 30° C. above the dew point.

Embodiment 7 is a steam plume suppression system, comprising: (a) a cooling shell and tube heat exchanger comprising a shell side inlet, a shell side outlet, a tube side inlet and a tube side outlet; (b) a heating shell and tube heat exchanger comprising a shell side inlet, a shell side outlet, a tube side inlet and a tube side outlet; and (c) a wet scrubber comprising a gas inlet and a scrubbed gas outlet; wherein the tube side outlet of the cooling shell and tube heat exchanger is connected with the gas inlet of the wet scrubber, the scrubbed gas outlet of the wet scrubber is connected with the tube side inlet of the heating shell and tube heat exchanger, the shell side outlet of the cooling shell and tube heat exchanger is connected with the shell side inlet of the heating shell and tube heat exchanger, and the shell side outlet of the heating shell and tube heat exchanger is connected with the shell side inlet of the cooling shell and tube heat exchanger.

Embodiment 8 is a steam plume suppression system as set forth in embodiment 7, wherein the tube side outlet of the cooling shell and tube heat exchanger is directly connected to the gas inlet of the wet scrubber.

Embodiment 9 is a steam plume suppression system as set forth in embodiment 7, wherein the scrubbed gas outlet of the wet scrubber is directly connected to the tube side inlet of the heating shell and tube heat exchanger.

Embodiment 10 is a steam plume suppression system as set forth in embodiment 7, wherein the shell side outlet of the cooling shell and tube heat exchanger is directly connected with the shell side inlet of the heating shell and tube heat exchanger, and the shell side outlet of the heating shell and tube heat exchanger is directly connected with the shell side inlet of the cooling shell and tube heat exchanger.

Embodiment 11 is a steam plume suppression system as set forth in embodiment 7, wherein the shell side outlet of the heating shell and tube heat exchanger is at a higher elevation than the shell side inlet of the cooling shell and tube heat exchanger, and the shell side inlet of the heating shell and tube heat exchanger is at a higher elevation than the shell side outlet of the cooling shell and tube heat exchanger.

Embodiment 12 is a steam plume suppression system, comprising: (a) a cooling shell and tube heat exchanger comprising a shell side inlet, a shell side outlet, a tube side inlet and a tube side outlet; (b) a heating shell and tube heat exchanger comprising a shell side inlet, a shell side outlet, a tube side inlet and a tube side outlet; and (c) a wet scrubber comprising a gas inlet and a scrubbed gas outlet; wherein the shell side outlet of the cooling shell and tube heat exchanger is connected with the gas inlet of the wet scrubber, the scrubbed gas outlet of the wet scrubber is connected with the shell side inlet of the heating shell and tube heat exchanger, the tube side outlet of the cooling shell and tube heat exchanger is connected with the tube side inlet of the heating shell and tube heat exchanger, and the tube side outlet of the heating shell and tube heat exchanger is connected with the tube side inlet of the cooling shell and tube heat exchanger.

Embodiment 13 is a steam plume suppression system as set forth in embodiment 12, wherein the shell side outlet of the cooling shell and tube heat exchanger is directly connected to the gas inlet of the wet scrubber.

Embodiment 14 is a steam plume suppression system as set forth in embodiment 12, wherein the scrubbed gas outlet of the wet scrubber is directly connected to the shell side inlet of the heating shell and tube heat exchanger.

Embodiment 15 is a steam plume suppression system as set forth in embodiment 12, wherein the tube side outlet of the cooling shell and tube heat exchanger is directly connected with the tube side inlet of the heating shell and tube heat exchanger, and the tube side outlet of the heating shell and tube heat exchanger is directly connected with the tube side inlet of the cooling shell and tube heat exchanger.

Embodiment 16 is a steam plume suppression system as set forth in embodiment 12, wherein the tube side outlet of the heating shell and tube heat exchanger is at a higher elevation than the tube side inlet of the cooling shell and tube heat exchanger, and the tube side inlet of the heating shell and tube heat exchanger is at a higher elevation than the tube side outlet of the cooling shell and tube heat exchanger.

Embodiment 17 is a process for steam plume suppression, comprising: (a) providing an integrated shell and tube heat exchanger comprising a shell, a plurality of tubes, and a substantially horizontal tube sheet sealingly engaging the tubes and an interior wall of the shell and defining an upper chamber and a lower chamber within the integrated shell and tube heat exchanger, wherein the plurality of tubes extend upwardly from the lower chamber to the upper chamber; (b) providing a heat transfer fluid to be circulated on the tube side between the lower chamber and the upper chamber (c) passing a hot gas stream through the shell side of the lower chamber to heat a liquid heat transfer fluid contained on the tube side of the lower chamber to form a heat transfer fluid vapor which rises to the tube side of the upper chamber while the hot gas stream is cooled to form a cooled hot gas stream; and (d) passing a wet gas comprising water vapor through the shell side of the upper chamber so that the wet gas is heated to above the dew point and the heat transfer fluid vapor contained on the tube side of the upper chamber is cooled and condensed to form the liquid heat transfer fluid which is circulated to the tube side of the lower chamber, wherein the cooled hot gas stream exiting from the shell side of the lower chamber is directed to a wet scrubber to generate the wet gas comprising water vapor.

Embodiment 18 is a process for steam plume suppression as set forth in embodiment 17, wherein the upper chamber and the lower chamber have substantially the same volume.

Embodiment 19 is a process for steam plume suppression as set forth in embodiment 17, wherein the heat transfer fluid consists essentially of water.

Embodiment 20 is a process for steam plume suppression as set forth in embodiment 17, wherein the wet gas is substantially saturated with water vapor.

Embodiment 21 is a process for steam plume suppression as set forth in embodiment 17, wherein the wet gas is heated to a temperature at least about 30° C. above the dew point.

Embodiment 22 is a process for steam plume suppression as set forth in embodiment 17, wherein the plurality of tubes are substantially vertical.

Embodiment 23 is a steam plume suppression system, comprising: (a) an integrated shell and tube heat exchanger comprising a shell, a plurality of tubes, and a substantially horizontal tube sheet sealingly engaging the tubes and an interior wall of the shell and defining an upper chamber and a lower chamber within the integrated shell and tube heat exchanger, wherein the plurality of tubes extend upwardly from the lower chamber to the upper chamber, and the upper chamber and the lower chamber each has a shell side inlet and a shell side outlet; and (b) a wet scrubber comprising a gas inlet and a scrubbed gas outlet;

wherein the shell side outlet of the lower chamber is connected with the gas inlet of the wet scrubber, and the scrubbed gas outlet of the wet scrubber is connected with the shell side inlet of the upper chamber.

Embodiment 24 is a steam plume suppression system as set forth in embodiment 23, wherein the upper chamber and the lower chamber have substantially the same volume.

Embodiment 25 is a steam plume suppression system as set forth in embodiment 23, wherein the shell side outlet of the lower chamber is directly connected to the gas inlet of the wet scrubber.

Embodiment 26 is a steam plume suppression system as set forth in embodiment 23, wherein the scrubbed gas outlet of the wet scrubber is directly connected to the shell side inlet of the upper chamber.

Embodiment 27 is a steam plume suppression system as set forth in embodiment 23, wherein the plurality of tubes are substantially vertical.

1. A process for steam plume suppression, comprising:
(a) providing a cooling shell and tube heat exchanger, a heating shell and tube heat exchanger, and a heat transfer fluid to be circulated on the shell side between the cooling shell and tube heat exchanger and the heating shell and tube heat exchanger;
(b) passing a hot gas stream through the tube side of the cooling shell and tube heat exchanger to heat a liquid heat transfer fluid contained on the shell side of the cooling shell and tube heat exchanger to form a heat transfer fluid vapor while the hot gas stream is cooled to form a cooled hot gas stream;
(c) circulating the heat transfer fluid vapor to the shell side of the heating shell and tube heat exchanger;
(d) passing a wet gas comprising water vapor through the tube side of the heating shell and tube heat exchanger so that the wet gas is heated to above the dew point and the heat transfer fluid vapor contained on the shell side of the heating shell and tube heat exchanger is cooled and condensed to form the liquid heat transfer fluid; and
(e) circulating the liquid heat transfer fluid to the shell side of the cooling shell and tube heat exchanger;
wherein the cooled hot gas stream exiting from the tube side of the cooling shell and tube heat exchanger is directed to a wet scrubber to generate the wet gas comprising water vapor.

2. A process for steam plume suppression, comprising:
(a) providing a cooling shell and tube heat exchanger, a heating shell and tube heat exchanger, and a heat transfer fluid to be circulated on the tube side between the cooling shell and tube heat exchanger and the heating shell and tube heat exchanger;
(b) passing a hot gas stream through the shell side of the cooling shell and tube heat exchanger to heat a liquid heat transfer fluid contained on the tube side of the cooling shell and tube heat exchanger to form a heat transfer fluid vapor while the hot gas stream is cooled to form a cooled hot gas stream;
(c) circulating the heat transfer fluid vapor to the tube side of the heating shell and tube heat exchanger;
(d) passing a wet gas comprising water vapor through the shell side of the heating shell and tube heat exchanger so that the wet gas is heated to above the dew point and the heat transfer fluid vapor contained on the tube side of the heating shell and tube heat exchanger is cooled and condensed to form the liquid heat transfer fluid; and
(e) circulating the liquid heat transfer fluid to the tube side of the cooling shell and tube heat exchanger;
wherein the cooled hot gas stream exiting from the shell side of the cooling shell and tube heat exchanger is directed to a wet scrubber to generate the wet gas comprising water vapor.

3. The process of claim 1 wherein no pump is used to circulate the heat transfer fluid.

4. A steam plume suppression system, comprising:
(a) a cooling shell and tube heat exchanger comprising a shell side inlet, a shell side outlet, a tube side inlet and a tube side outlet;
(b) a heating shell and tube heat exchanger comprising a shell side inlet, a shell side outlet, a tube side inlet and a tube side outlet; and
(c) a wet scrubber comprising a gas inlet and a scrubbed gas outlet;
wherein the tube side outlet of the cooling shell and tube heat exchanger is connected with the gas inlet of the wet scrubber, the scrubbed gas outlet of the wet scrubber is connected with the tube side inlet of the heating shell and tube heat exchanger, the shell side outlet of the cooling shell and tube heat exchanger is connected with the shell side inlet of the heating shell and tube heat exchanger, and the shell side outlet of the heating shell and tube heat exchanger is connected with the shell side inlet of the cooling shell and tube heat exchanger.

5. The system of claim 4 wherein the shell side outlet of the cooling shell and tube heat exchanger is directly connected with the shell side inlet of the heating shell and tube heat exchanger, and the shell side outlet of the heating shell and tube heat exchanger is directly connected with the shell side inlet of the cooling shell and tube heat exchanger.

6. A steam plume suppression system, comprising:
(a) a cooling shell and tube heat exchanger comprising a shell side inlet, a shell side outlet, a tube side inlet and a tube side outlet;
(b) a heating shell and tube heat exchanger comprising a shell side inlet, a shell side outlet, a tube side inlet and a tube side outlet; and
(c) a wet scrubber comprising a gas inlet and a scrubbed gas outlet;
wherein the shell side outlet of the cooling shell and tube heat exchanger is connected with the gas inlet of the wet scrubber, the scrubbed gas outlet of the wet scrubber is connected with the shell side inlet of the heating shell and tube heat exchanger, the tube side outlet of the cooling shell and tube heat exchanger is connected with the tube side inlet of the heating shell and tube heat exchanger, and the tube side outlet of the heating shell and tube heat exchanger is connected with the tube side inlet of the cooling shell and tube heat exchanger.

7. The system of claim 6 wherein the tube side outlet of the cooling shell and tube heat exchanger is directly connected with the tube side inlet of the heating shell and tube heat exchanger, and the tube side outlet of the heating shell and tube heat exchanger is directly connected with the tube side inlet of the cooling shell and tube heat exchanger.

8. A process for steam plume suppression, comprising:
(a) providing an integrated shell and tube heat exchanger comprising a shell, a plurality of tubes, and a substantially horizontal tube sheet sealingly engaging the tubes and an interior wall of the shell and defining an upper chamber and a lower chamber within the integrated shell and tube heat exchanger, wherein the plurality of tubes extend upwardly from the lower chamber to the upper chamber;
(b) providing a heat transfer fluid to be circulated on the tube side between the lower chamber and the upper chamber;
(c) passing a hot gas stream through the shell side of the lower chamber to heat a liquid heat transfer fluid contained on the tube side of the lower chamber to form a heat transfer fluid vapor which rises to the tube side of the upper chamber while the hot gas stream is cooled to form a cooled hot gas stream; and
(d) passing a wet gas comprising water vapor through the shell side of the upper chamber so that the wet gas is heated to above the dew point and the heat transfer fluid vapor contained on the tube side of the upper chamber is cooled and condensed to form the liquid heat transfer fluid which is circulated to the tube side of the lower chamber;
wherein the cooled hot gas stream exiting from the shell side of the lower chamber is directed to a wet scrubber to generate the wet gas comprising water vapor.

9. The process of claim 8 wherein the heat transfer fluid consists essentially of water.

10. A steam plume suppression system, comprising:
(a) an integrated shell and tube heat exchanger comprising a shell, a plurality of tubes, and a substantially horizontal tube sheet sealingly engaging the tubes and an interior wall of the shell and defining an upper chamber and a lower chamber within the integrated shell and tube heat exchanger, wherein the plurality of tubes extend upwardly from the lower chamber to the upper chamber, and the upper chamber and the lower chamber each has a shell side inlet and a shell side outlet; and
(b) a wet scrubber comprising a gas inlet and a scrubbed gas outlet;
wherein the shell side outlet of the lower chamber is connected with the gas inlet of the wet scrubber, and the scrubbed gas outlet of the wet scrubber is connected with the shell side inlet of the upper chamber.

11. The process of claim 2, wherein no pump is used to circulate the heat transfer fluid.

12. The process of claim 1, wherein the heat transfer fluid consists essentially of water.

13. The process of claim 2, wherein the heat transfer fluid consists essentially of water.
